(19) United States
(12) Patent Application Publication
(10) Pub. No.: US 2025/0364747 A1
(43) Pub. Date: Nov. 27, 2025

(54) ELECTRIC WIRE FIXING STRUCTURE

(71) Applicant: Yazaki Corporation, Tokyo (JP)

(72) Inventors: Motonori MIYANARI, Shizuoka (JP); Kei SATO, Shizuoka (JP); Takuya OTAKE, Shizuoka (JP)

(73) Assignee: Yazaki Corporation, Tokyo (JP)

(21) Appl. No.: 19/209,315

(22) Filed: May 15, 2025

(30) Foreign Application Priority Data
May 24, 2024 (JP) 2024-085074

(51) Int. Cl. H01R 13/40; H01R 24/20

(52) U.S. Cl. CPC H01R 13/40; H01R 24/20

(57) ABSTRACT

In an electric wire fixing structure including an electric wire including a sheath portion covering an outer periphery of a plurality of inner electric wires, and an arrangement member being arranged on the sheath portion and the inner electric wire exposed from the sheath portion with respect to an outer periphery of the electric wire, the arrangement member includes a sheath fixing portion fixed to the sheath portion and an inner fixing portion fixed to the plurality of inner electric wires.

### CROSS-REFERENCE TO RELATED APPLICATIONS

The present application is based on, and claims priority from the prior Japanese Patent Application No. 2024-085074, filed on May 24, 2024, the entire contents of which are incorporated herein by reference.

### TECHNICAL FIELD

The present disclosure relates to an electric wire fixing structure.

### BACKGROUND

Hitherto, there has been known an electric wire fixing structure that includes a twist pair cable as an electric wire including a sheath portion covering an outer periphery of a communication wire formed of a plurality of inner electric wires. The electric wire fixing structure further includes a fastening member as an arrangement member that is arranged on the sheath portion and the communication wire exposed from the sheath portion with respect to the outer periphery of the twist pair cable (see JP 2021-51846 A). In the electric wire fixing structure, the fastening member includes a barrel portion that is fastened by the outer periphery of the sheath portion and a non-fastening portion that is arranged in the periphery of the communication wire exposed from the sheath portion. The fastening member is fixed to the twist pair cable by fastening the barrel portion onto the outer periphery of the sheath portion. The non-fastening portion of the fastening member is arranged in the periphery of the communication wire so that impedance of the communication wire exposed from the sheath portion falls within a desired range.

### SUMMARY OF THE INVENTION

Incidentally, in the electric wire including the sheath portion covering the outer periphery of the plurality of inner electric wires, the adhesion force between the plurality of inner electric wires and the sheath portion is weak. Thus, when the tensile force is applied to the electric wire, the inner electric wire and the sheath portion are pulled independently of each other. In the electric wire fixing structure in JP 2021-51846 A, the arrangement member is fixed only to the sheath portion of the electric wire. Thus, when the tensile force is applied to the electric wire, the arrangement member moves following the sheath portion, and the arrangement position of the arrangement member with respect to the inner electric wire exposed from the sheath portion fluctuates. As a result, the arrangement member may not protect the inner electric wire in a stable manner. In addition, in a case in which the arrangement position of the arrangement member is fixed, when the tensile force is applied to the sheath portion, the sheath portion easily stretches, thereby reducing the thickness thereof. When the thickness is reduced, protection of the inner electric wire may be unstable.

The present disclosure has been made in view of such a problem in the related art. Further, an object of the present disclosure is to provide an electric wire fixing structure that can protect an inner electric wire in a stable manner.

An electric wire fixing structure according to an embodiment includes an electric wire including a plurality of inner wires and a sheath portion covering an outer periphery of the plurality of inner electric wires, and an arrangement member being arranged on the sheath portion and the inner electric wire exposed from the sheath portion with respect to an outer periphery of the electric wire, wherein the arrangement member includes a sheath fixing portion fixed to the sheath portion and an inner fixing portion fixed to the plurality of inner electric wires.

According to the present disclosure, an electric wire fixing structure that can protect an inner electric wire in a stable manner can be provided.

### BRIEF DESCRIPTION OF DRAWINGS

FIG. 1 is a perspective view of an electric wire fixing structure according to the present embodiment.

FIG. 2 is an exploded perspective view of the electric wire fixing structure according to the present embodiment.

FIG. 3 is a perspective view illustrating a state in which an outer terminal is assembled to a terminal portion of an electric wire of the electric wire fixing structure according to the present embodiment.

FIG. 4 is a cross-sectional view of FIG. 3.

FIG. 5 is an enlarged view of main parts of FIG. 4.

FIG. 6 is a perspective view illustrating a state in which an inner housing is assembled to the terminal portion of the electric wire of the electric wire fixing structure according to the present embodiment.

FIG. 7 is a perspective view illustrating a state in which an inner terminal is assembled to the terminal portion of the electric wire of the electric wire fixing structure according to the present embodiment.

FIG. 8 is a side view of the electric wire of the electric wire fixing structure according to the present embodiment.

FIG. 9 is a perspective view of an arrangement member of the electric wire fixing structure according to the present embodiment.

FIG. 10 is a perspective view illustrating a state in which the arrangement member of the electric wire fixing structure according to the present embodiment is deployed.

FIG. 11 is a cross-sectional view illustrating a state in which an inner fixing portion of the arrangement member of the electric wire fixing structure according to the present embodiment is fixed to inner electric wires.

FIG. 12 is a cross-sectional view illustrating a state in which an inner fixing portion in another example of the arrangement member of the electric wire fixing structure according to the present embodiment is fixed to the inner electric wires.

FIG. 13 is a cross-sectional view illustrating a state in which an inner fixing portion in another example of the arrangement member of the electric wire fixing structure according to the present embodiment is fixed to the inner electric wires.

### DETAILED DESCRIPTION OF THE INVENTION

With reference to the drawings, an electric wire fixing structure according to the present embodiment is described in detail. Note that the dimensional ratios in the drawings are exaggerated for explanatory purposes, and may differ from the actual ratios.

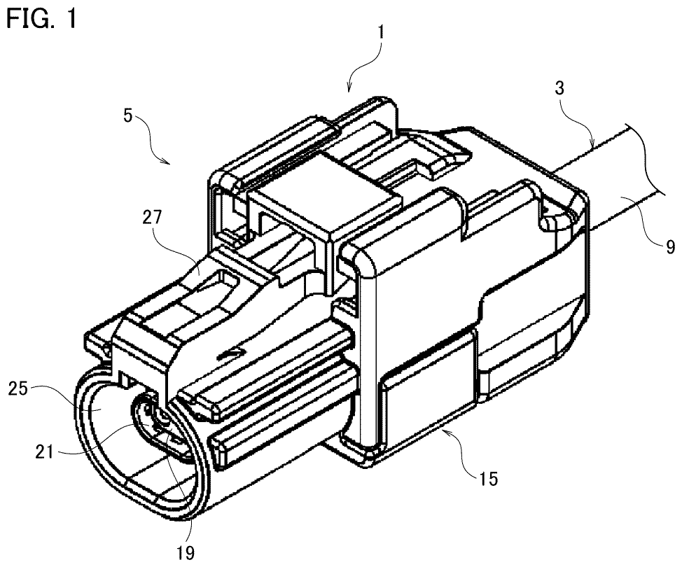

As illustrated in FIG. 1, an electric wire fixing structure 1 according to the present embodiment is applied to a connector 5 for high-speed communication transmission, which performs information communication between two electric components (omitted in illustration), for example, between a power source and a device or between a device and a device. The connector 5 is provided to a terminal portion of an electric wire 3 electrically connected to one electric component. The connector 5 can be fitted to a mating connector (omitted in illustration) electrically connected to the other electric component. When the connector 5 is fitted to the mating connector, the connector 5 is electrically connected to the mating connector, which enables information communication between the two electric components.

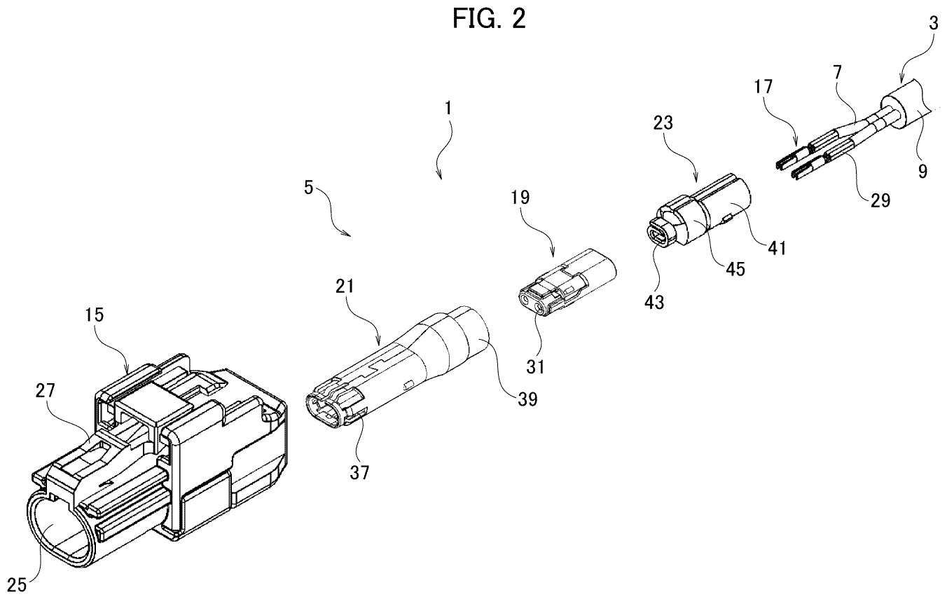

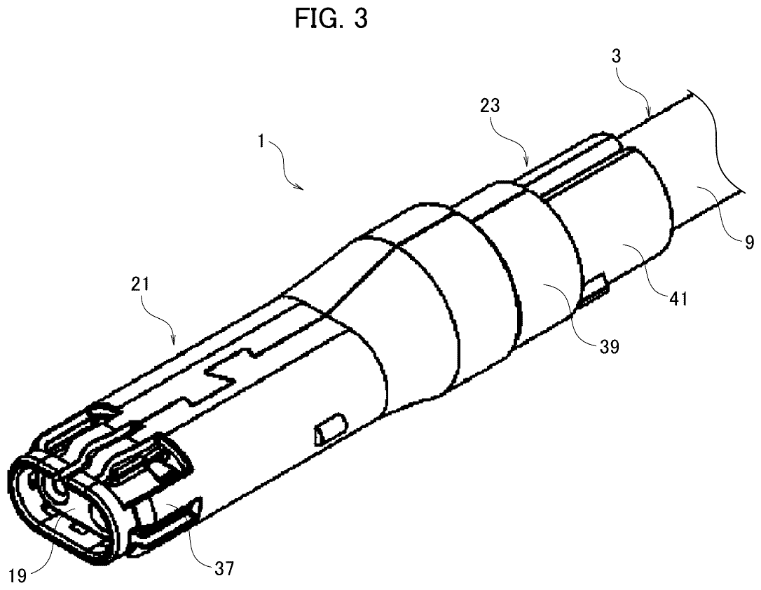

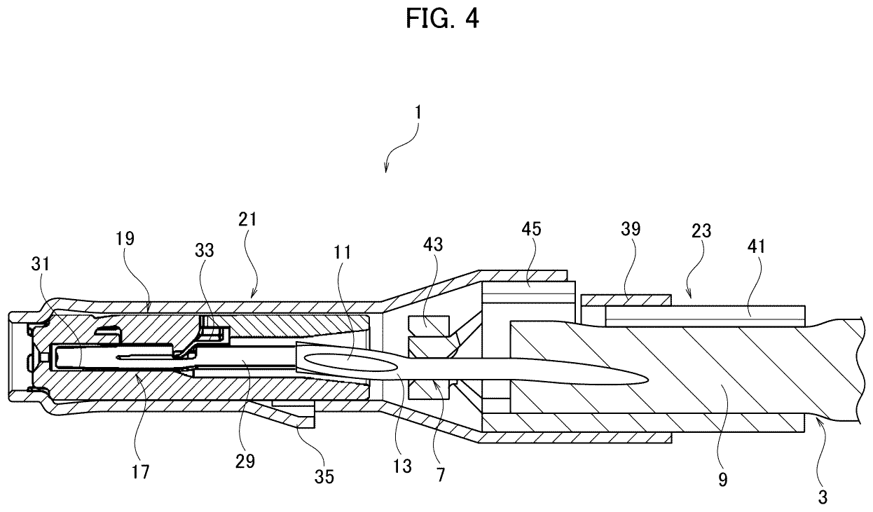

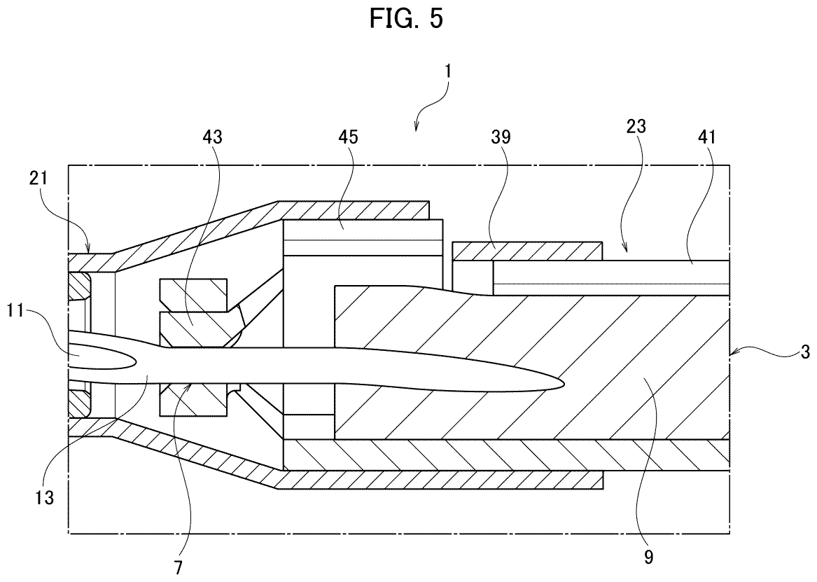

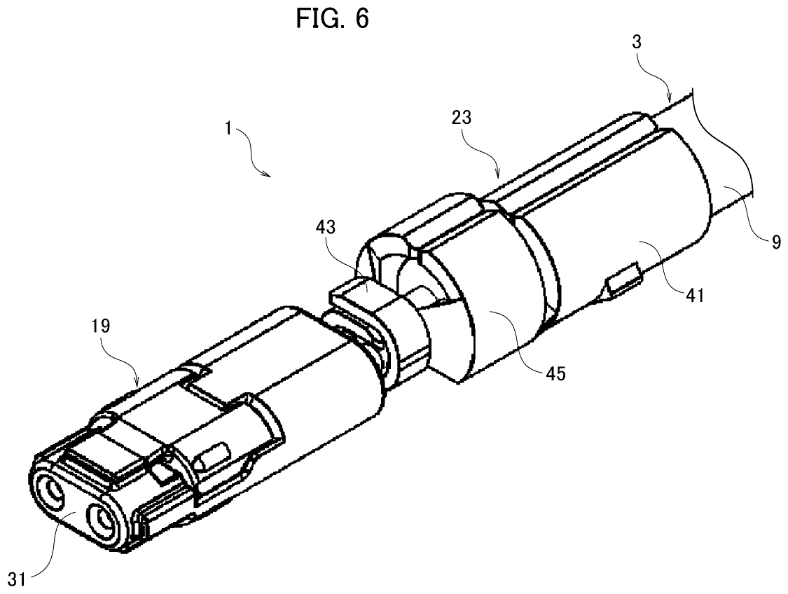

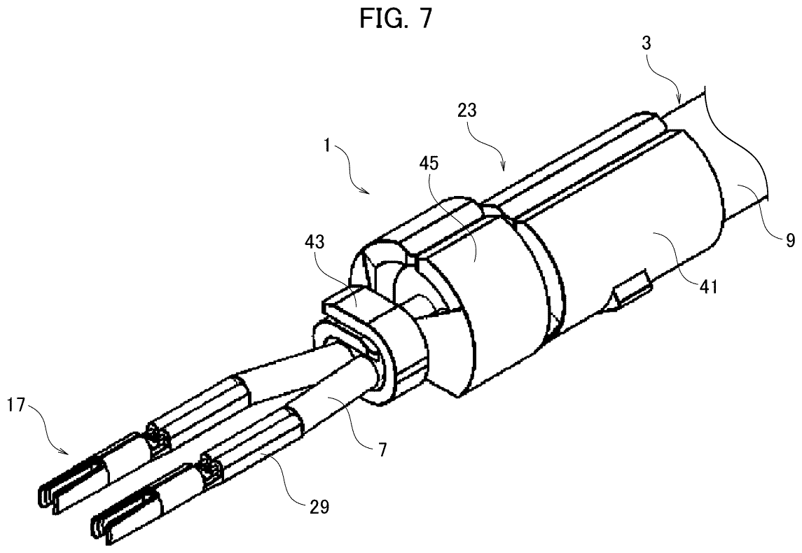

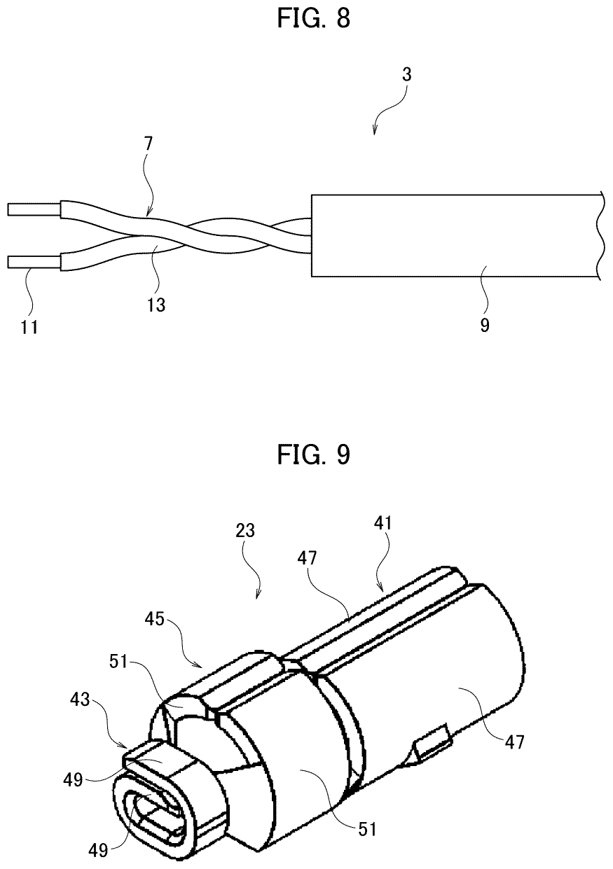

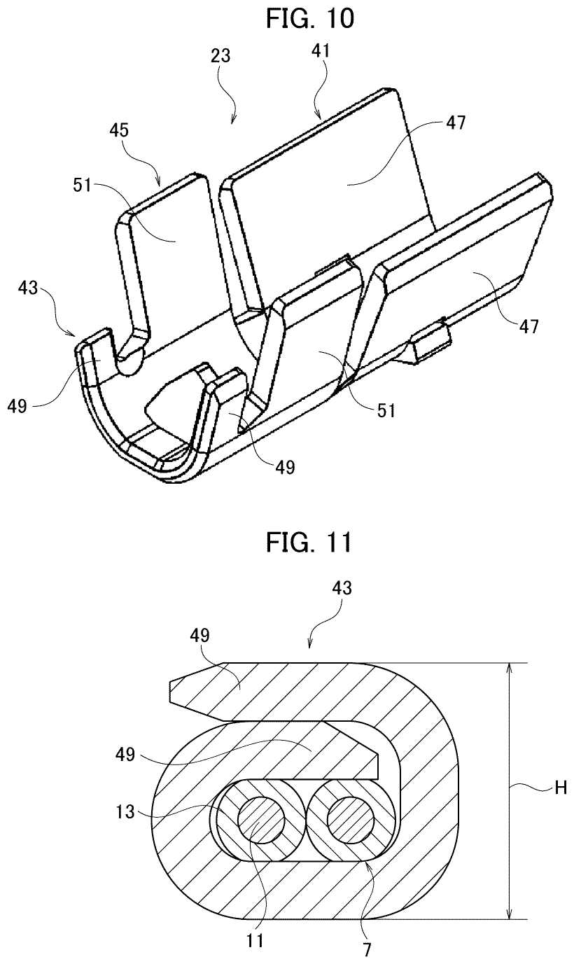

As illustrated in FIG. 1 to FIG. 13, the electric wire fixing structure 1 includes the electric wire 3 and the connector 5.

As illustrated in FIG. 1 to FIG. 8, the electric wire 3 includes an inner electric wire 7 and a sheath portion 9.

For example, the inner electric wire 7 is formed of a core wire 11 that is formed by twisting a plurality of element wires formed of an electroconductive material and an insulating cover 13 that is formed of an insulating material such as a synthetic resin and covers an outer periphery of the core wire 11. One end of the inner electric wire 7 is electrically connected to the one electric component. Two inner electric wires 7 are twisted and bundled, and the outer periphery thereof is covered with the sheath portion 9.

The sheath portion 9 is formed of an insulating material such as a synthetic resin. The sheath portion 9 is arranged to cover the outer periphery of the two twisted inner electric wires 7. The inner electric wire 7 is arranged to be exposed from one end of the sheath portion 9.

The electric wire 3 in which the sheath portion 9 covers the outer periphery of the two twisted inner electric wires 7 is referred to as a twist pair cable. Note that, for example, the plurality of inner electric wires 7 may consist of a total of four wires in two pairs, a total of eight wires in four pairs, or any other number. When the electric wire 3 does not include a shielding member (omitted in illustration) such as a braid and a metal foil that covers the outer periphery of the inner electric wire 7, the electric wire 3 is also referred to as an unshielded twist pair (UTP) cable. Note that the electric wire 3 may be a shielded twist pair (STP) cable in which the outer periphery of the inner electric wire 7 is covered with a shielding member. The terminal portion of the electric wire 3 is provided with the connector 5.

As illustrated in FIG. 1 to FIG. 7 and FIG. 9 to FIG. 13, the connector 5 includes an outer housing 15, an inner terminal 17, an inner housing 19, an outer terminal 21, and an arrangement member 23.

The outer housing 15 is formed of an insulating material such as a synthetic resin. The outer housing 15 is provided with a fitting portion 25 that can be fitted to a mating housing of the mating connector (omitted in illustration). The outer housing 15 is provided with a locking arm 27 that can be elastically deformed to maintain the fitting state with the mating housing. The outer housing 15 accommodates the inner terminal 17 assembled to the terminal portion of the electric wire 3, the inner housing 19, the outer terminal 21, and the arrangement member 23, and the electric wire 3 is drawn to the outside.

The inner terminal 17 is formed of an electroconductive material, and is formed of a female terminal including a box-like connecting portion. At the terminal portion of the electric wire 3, the inner terminal 17 is arranged at a terminal portion of each of the plurality of untwisted inner electric wires 7 (specifically, two in this case) exposed from the sheath portion 9. A crimping portion 29 formed of a crimping piece is crimped onto the core wire 11 exposed from the insulating cover 13 of the inner electric wire 7, and thus the inner terminal 17 is electrically connected to the inner electric wire 7. When the connector 5 and the mating connector are fitted to each other, the inner terminal 17 is electrically connected to a male mating terminal (omitted in illustration) of the mating connector, the male mating terminal including a tab-like connecting portion. Consequently, the two electric components are electrically connected to each other. The inner terminal 17 is accommodated in the inner housing 19.

The inner housing 19 is formed of an insulating material such as a synthetic resin. The inner housing 19 is formed to have a cylinder shape so as to include a plurality of terminal accommodation chambers 31 (specifically, two in this case) that can accommodate the plurality of inner terminals 17 (specifically, two in this case), respectively. The terminal accommodation chamber 31 of the inner housing 19 is provided with an engaging lance 33 that is engaged with the inner terminal 17 and can be elastically deformed to hold the inner terminal 17 in the inner housing 19. The inner housing 19 is accommodated in the outer terminal 21, and maintains the insulation between the inner terminal 17 and the outer terminal 21.

The outer terminal 21 is formed of an electroconductive material, and is formed to have a cylinder shape so as to accommodate the inner housing 19. The outer terminal 21 is provided with an engaging protrusion 35 that is engaged with an engaging lance (omitted in illustration) that is provided inside the outer housing 15 in an elastically deformable manner. When the engaging lance and the engaging protrusion 35 are engaged with each other, the outer terminal 21 is held in the outer housing 15. The outer terminal 21 is provided with a plurality of contact pieces 37 that can be elastically deformed to contact with a mating shielding member (omitted in illustration) of the mating connector. When the connector 5 and the mating connector are fitted to each other, the outer terminal 21 is electrically connected to the mating shielding member to form a shielding circuit. When the shielding circuit is formed, entry of a noise and the like into the inner terminal 17 and the mating terminal and leakage of a noise and the like from the inner terminal 17 and the mating terminal can be prevented. The outer terminal 21 is provided with an arrangement connecting portion 39 formed of a pair of fastening pieces. When the pair of fastening pieces are fastened onto the outer periphery of the arrangement member 23, the arrangement connecting portion 39 fixes the outer terminal 21 and the arrangement member 23 to each other, and electrically connects the outer terminal 21 and the arrangement member 23 to each other.

The arrangement member 23 is formed of an electroconductive material, and includes a sheath fixing portion 41, an inner fixing portion 43, and a terminal connecting portion 45.

The sheath fixing portion 41 includes a pair of fastening pieces 47 and 47 that extend upward from both the side surfaces of the bottom wall, respectively. The sheath fixing portion 41 is arranged at the outer periphery of the sheath portion 9 of the electric wire 3, and the pair of fastening pieces 47 and 47 are fastened onto the outer periphery of the sheath portion 9 so that the distal ends thereof match with each other. When the pair of fastening pieces 47 and 47 are fastened onto the sheath portion 9, the arrangement member 23 is fixed to the electric wire 3 via the sheath fixing portion 41.

The inner fixing portion 43 includes a pair of crimping pieces 49 and 49 that are formed of one member continuous with the sheath fixing portion 41 via the bottom wall and extend upward from both the side surfaces from the bottom wall, respectively. One crimping piece 49 of the pair of crimping pieces 49 and 49 is formed to be longer than the other crimping piece 49. The inner fixing portion 43 is arranged on the outer periphery of the inner electric wire 7 exposed from the sheath portion 9 of the electric wire 3, and is fastened onto the outer periphery of the insulating cover 13 of the plurality of inner electric wires 7 so that the one crimping piece 49 overlaps on the other crimping piece 49. When the pair of crimping pieces 49 and 49 are fastened onto the inner electric wire 7, the arrangement member 23 is fixed to the electric wire 3 via the inner fixing portion 43. With respect to the plurality of inner electric wires 7 exposed from the sheath portion 9, the pair of crimping pieces 49 and 49 of the inner fixing portion 43 are fastened onto the part where the plurality of inner electric wires 7 are twisted. Thus, the plurality of inner electric wires 7 exposed from the sheath portion 9 can be kept twisted, fluctuation of impedance of the plurality of inner electric wires 7 exposed from the sheath portion 9 can be suppressed, and the inner electric wire 7 can be protected by the arrangement member 23.

As described above, the arrangement member 23 is fixed to the electric wire 3 via the sheath fixing portion 41 and the inner fixing portion 43. Thus, when the tensile force is applied to the electric wire 3, the tensile force can be distributed to the sheath fixing portion 41 and the inner fixing portion 43. When the tensile force is distributed to the sheath fixing portion 41 and the inner fixing portion 43, fluctuation of the arrangement position of the arrangement member 23 with respect to the inner electric wire 7 exposed from the sheath portion 9 can be suppressed, and protection of the inner electric wire 7 by the arrangement member 23 can be stabilized. In addition, the tensile force is not applied solely to the sheath fixing portion 41, and stretching of the sheath portion 9, which reduces the thickness thereof, is suppressed. Thus, protection of the inner electric wire 7 by the sheath portion 9 can be stabilized.

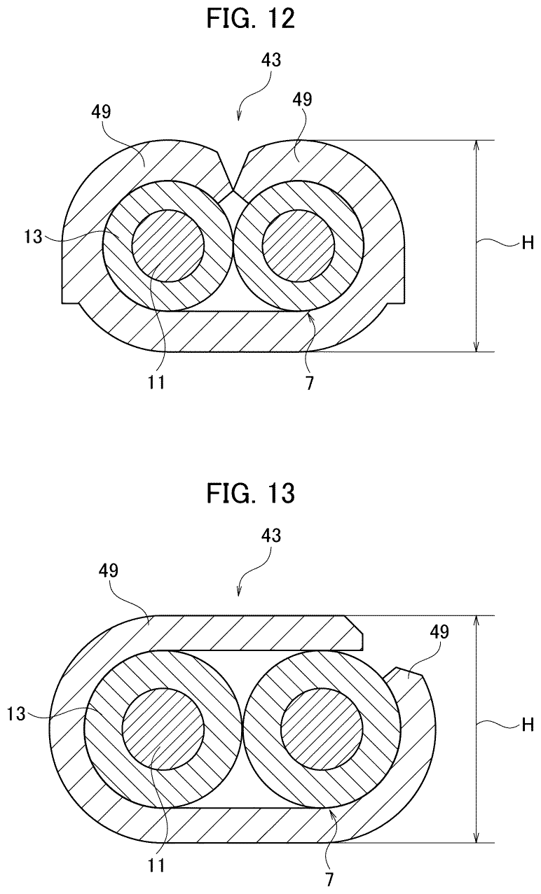

Here, as illustrated in FIG. 12, the inner fixing portion 43 may be fastened onto the plurality of inner electric wires 7 so that the distal ends of the pair of crimping pieces 49 and 49 having the same length match with each other. Further, as illustrated in FIG. 13, the inner fixing portion 43 may be fastened onto the plurality of inner electric wires 7 so that the distal ends of the pair of crimping pieces 49 and 49 having different lengths are close to each other. Note that the inner fixing portion 43 adjusts the fixing force of the arrangement member 23 with respect to the electric wire 3 by adjusting a height H when the pair of crimping pieces 49 and 49 are fastened onto the plurality of inner electric wires 7. For example, the fixing force can be increased by reducing the height H, and the fixing force can be reduced by increasing the height H. When the height H is adjusted, distribution of the tensile force to the sheath fixing portion 41 and the inner fixing portion 43 may be adjusted.

The terminal connecting portion 45 is formed of one member that is continuous with the sheath fixing portion 41 and the inner fixing portion 43 via the bottom wall, and is arranged between the sheath fixing portion 41 and the inner fixing portion 43. The terminal connecting portion 45 includes a pair of connecting pieces 51 and 51 that extend upward from both the side surfaces of the bottom wall, respectively. The pair of connecting pieces 51 and 51 are plastically deformed so that the distal ends thereof match with each other. With this, the terminal connecting portion 45 is formed to have an annular shape having a diameter larger than the sheath fixing portion 41. The terminal connecting portion 45 is accommodated in the outer terminal 21 so that the outer surface thereof contacts with the inner surface of the outer terminal 21, and thus electrically connects the outer terminal 21 and the arrangement member 23 to each other. When the outer terminal 21 and the arrangement member 23 are electrically connected to each other, the shielding circuit can be formed from the inner electric wire 7 exposed from the sheath portion 9 to the inner terminal 17, and the range of the shielding circuit can be expanded. With regard to the arrangement member 23 provided with the terminal connecting portion 45, fluctuation of the arrangement position thereof due to tensile force is suppressed by the inner fixing portion 43. Thus, contact between the outer terminal 21 and the terminal connecting portion 45 can be maintained, and reliability of electric connection between the outer terminal 21 and the arrangement member 23 can be maintained.

In an example of the assembly of the electric wire fixing structure 1 described above, first, at the terminal portion of the electric wire 3, the sheath portion 9 is peeled by a predetermined length. Subsequently, the arrangement member 23 is arranged over the sheath portion 9 and the plurality of inner electric wires 7 being exposed. Subsequently, the sheath fixing portion 41 of the arrangement member 23 is fixed to the outer periphery of the sheath portion 9, and the inner fixing portion 43 of the arrangement member 23 is fixed to the outer periphery of the plurality of inner electric wires 7. In this state, the terminal connecting portion 45 of the arrangement member 23 is formed to have an annular shape. Subsequently, at the terminal portion of the inner electric wire 7, the insulating cover 13 is peeled by a predetermined length. Subsequently, the crimping portion 29 of the inner terminal 17 is crimped onto the core wire 11 of the inner electric wire 7 being exposed. Subsequently, the inner terminal 17 is accommodated in the inner housing 19. Subsequently, the inner housing 19 is accommodated in the outer terminal 21. Subsequently, the arrangement connecting portion 39 of the outer terminal 21 is fixed to the arrangement member 23. Further, the outer terminal 21 is accommodated in the outer housing 15 to complete the assembly.

The electric wire fixing structure 1 described above includes the electric wire 3 that includes the sheath portion 9 covering the outer periphery of the plurality of inner electric wires 7, and the arrangement member 23 that is arranged on the sheath portion 9 and the inner electric wire 7 exposed from the sheath portion 9 with respect to the outer periphery of the electric wire 3. Further, the arrangement member 23 includes the sheath fixing portion 41 that is fixed to the sheath portion 9 and the inner fixing portion 43 that is fixed to the plurality of inner electric wires 7.

The arrangement member 23 is fixed to the electric wire 3 via the sheath fixing portion 41 and the inner fixing portion 43. Thus, when the tensile force is applied to the electric wire 3, the tensile force can be distributed to the sheath fixing portion 41 and the inner fixing portion 43. When the tensile force is distributed to the sheath fixing portion 41 and the inner fixing portion 43, fluctuation of the arrangement position of the arrangement member 23 with respect to the inner electric wire 7 exposed from the sheath portion 9 can be suppressed, and protection of the inner electric wire 7 by the arrangement member 23 can be stabilized. In addition, the tensile force is not applied solely to the sheath fixing portion 41, and stretching of the sheath portion 9, which reduces the thickness thereof, is suppressed. Thus, protection of the inner electric wire 7 by the sheath portion 9 can be stabilized.

Therefore, in the electric wire fixing structure 1 described above, the inner electric wire 7 can be protected in a stable manner.

Further, the inner terminal 17 is electrically connected to the terminal portion of the inner electric wire 7 exposed from the sheath portion 9. Further, the inner terminal 17 is accommodated in the inner housing 19 formed of an insulating material. Further, the inner housing 19 is accommodated in the outer terminal 21. Further, the arrangement member 23 is formed of an electroconductive material, and includes the terminal connecting portion 45 electrically connected to the outer terminal 21.

When the arrangement member 23 is electrically connected to the outer terminal 21, the shielding circuit can be formed from the inner electric wire 7 exposed from the sheath portion 9 to the inner terminal 17, and the range of the shielding circuit can be expanded. In addition, fluctuation of the arrangement position of the arrangement member 23 due to tensile force is suppressed by the inner fixing portion 43. Thus, fluctuation of the arrangement position of the terminal connecting portion 45 with respect to the outer terminal 21 can be suppressed, and reliability of electric connection between the outer terminal 21 and the arrangement member 23 can be maintained.

While the present embodiment is described above, the present embodiment is not limited thereto, and various modifications can be made within the scope of the gist of the present embodiment.

For example, the terminal connecting portion of the arrangement member is formed to have an annular shape so as to be accommodated in the outer terminal, but the terminal connecting portion is not limited thereto. For example, the terminal connecting portion may be a contact piece or the like that can be elastically deformed to contact with the outer surface of the outer terminal. The terminal contacting portion may have any form.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electric wire fixing structure comprising:
an electric wire including a plurality of inner electric wires and a sheath portion covering an outer periphery of the plurality of inner electric wires; and
an arrangement member being arranged on the sheath portion and the inner electric wire exposed from the sheath portion with respect to an outer periphery of the electric wire, wherein
the arrangement member includes a sheath fixing portion fixed to the sheath portion and an inner fixing portion fixed to the plurality of inner electric wires.

2. The electric wire fixing structure according to claim 1, wherein
an inner terminal is electrically connected to a terminal portion of each of the inner electric wires exposed from the sheath portion,
the inner terminal is accommodated in an inner housing formed of an insulating material,
the inner housing is accommodated in an outer terminal, and
the arrangement member is formed of an electroconductive material, and includes a terminal connecting portion electrically connected to the outer terminal.
